(19) United States
(12) Patent Application Publication
(10) Pub. No.: US 2021/0046523 A1
(43) Pub. Date: Feb. 18, 2021

(54) PROTECTIVE COVER AND METHOD

(71) Applicant: EVISHIELD LIMITED (GB), Ashbourne (GB)

(72) Inventor: Adrian Robert DUPRE-PICKEN, Ashbourne (GB)

(21) Appl. No.: 16/965,512

(22) PCT Filed: Jan. 9, 2019
(86) PCT No.: PCT/GB2019/050048

§ 371 Date: Jul. 28, 2020

(30) Foreign Application Priority Data
Jan. 29, 2018 (GB) 1801397.9

(51) Int. Cl. B08B 17/04; G01N 1/00

(52) U.S. Cl. CPC B08B 17/04; G01N 1/00

(57) ABSTRACT

Certain examples of the present invention relate to a protective cover 100, and method of using the same, for protecting forensic evidence 104 and/or a forensic scene 604′. The cover 100 comprises a covering member 101 for at least partially covering forensic evidence 104 and/or an entry way to a forensic scene 604′, wherein the covering member 101 is configured to be breathable 106 and waterproof 107; a fixing means 102 for affixing the cover 100 to a surface 105 in an affixed condition 100′, wherein the affixing means 102 is provided at each peripheral edge 101a-101d of the covering member 101; and tamper indicating means 103 for indicating tampering of the cover in the affixed condition 100′, wherein the tamper indicating means 103 is provided at each peripheral edge 101a-101d of the covering member 101.

### CROSS REFERENCE TO RELATED APPLICATION

This application is a US national stage entry of International Patent Application No. PCT/GB2019/050048, filed Jan. 9, 2019, which claims priority to GB1801397.9 filed Jan. 29, 2018, the entire contents of each of which are incorporated herein by reference.

### TECHNOLOGICAL FIELD

Examples of the present disclosure relate to a protective cover. Some examples, though without prejudice to the foregoing, relate to a cover for protecting forensic evidence and/or a forensic scene.

### BACKGROUND

Current provisions for police officers, emergency services personnel or other first responders to protect and preserve forensic evidence when they attend a forensic scene (such as a crime scene or scene of an accident/incident) that enables the protection and preservation of forensic evidence (be it visible or latent forensic evidence) let alone preserving the continuity and integrity of the evidence are sub-optimal. Evidence may be lost due to exposure to the elements (moisture, water, precipitation, wind, UV) or via accidental damage. Accordingly, detection opportunities can be missed in the time between the arrival of a first responder (e.g. the police) at a scene to when a forensic examiner from the forensic service attends the scene and completes his/her evidence gathering.

Various examples of the present disclosure seek to provide an apparatus that may enable the protection and preservation of latent and visible forensic evidence and/or a forensic scene, whilst also ensuring the integrity and authenticity of the forensic evidence. Such forensic evidence may relate to, not least for example: blood, fingerprints and other evidence giving materials.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

According to one or more examples of the disclosure there is provided a cover for protecting forensic evidence and/or a forensic scene, the cover comprising:
a covering member for at least partially covering forensic evidence, wherein the covering member is configured to be breathable and waterproof;
affixing means for affixing the cover to a surface in an affixed condition, wherein the affixing means is provided at each peripheral edge of the covering member; and
tampering indicating means for indicating tampering of the cover in the affixed condition, wherein the tampering indicating means is provided at each peripheral edge of the covering member.

According to one or more examples of the disclosure there is provided a method of protecting forensic evidence and/or forensic scene comprising:
affixing a cover per the above around forensic evidence and/or an entryway to a forensic scene.

According to one or more examples of the disclosure there are provided examples as claimed in the appended claims.

### BRIEF DESCRIPTION OF THE DRAWINGS

For a better understanding of various examples of the present disclosure that are useful for understanding the detailed description and certain embodiments of the invention, reference will now be made by way of example only to the accompanying drawings in which:

FIG. 1 schematically illustrates an example of an apparatus according to an example of the present disclosure;

FIG. 2 schematically illustrates the apparatus of FIG. 1 in use;

FIGS. 3A, 3B and 3C schematically illustrate a further example of an apparatus according to the present disclosure;

FIGS. 4A to 4D schematically illustrate an example of tamper indicating means of apparatuses according to the present disclosure;

FIG. 5 schematically illustrates an example of a system according to the present disclosure; and

FIGS. 6A to 6D illustrate examples of use of apparatuses according to the present disclosure.

The Figures are not necessarily to scale. Certain features and views of the figures may be shown schematically or exaggerated in scale in the interest of clarity and conciseness. For example, the dimensions of some elements in the figures may be exaggerated relative to other elements to aid explication. Similar reference numerals are used in the Figures to designate similar features. For clarity, all reference numerals are not necessarily displayed in all figures.

### DETAILED DESCRIPTION

The Figures schematically illustrate a cover 100 for protecting forensic evidence 104 and/or a forensic scene 604′, the cover 100 comprising:
a covering member 101 for at least partially covering forensic evidence 104 and/or an entry way to a forensic scene 604′, wherein the covering member 101 is configured to be breathable 106 and waterproof 107;
a fixing means 102 for affixing the cover 100 to a surface 105 in an affixed condition 100′, wherein the affixing means 102 is provided at each peripheral edge 101a-101d of the covering member 101; and
tamper indicating means 103 for indicating tampering of the cover in the affixed condition 100′, wherein the tamper indicating means 103 is provided at each peripheral edge 101a-101d of the covering member 101.

For the purposes of illustration and not limitation, in some examples the cover comprises a planar sheet of waterproof yet breathable material which has a tamper evident adhesive seal surrounding its entire exterior edges. The tamper evidence adhesive seal provides both means by which to affix the cover to a surface as well as providing tamper indicting means which allows for immediate visual recognition if the cover, once having been affixed to a surface, has been tampered with (for example if an attempt has been made to remove the cover from the surface to which is has been affixed). The tamper indicating means help establish and validate the integrity of the evidence, i.e. to confirm/prove that it has not been tampered with.

In certain examples, such combined affixing and tamper indicating means may comprise a layer of adhesive that is configured to leave a predetermined portion of its adhesive (e.g. a die cut portion) on the surface to which the cover have been affixed upon attempted removal of the cover once affixed to the surface. The adhesive may be opaque or combined with an opaque colouring, such that the portion of the adhesion left on the surface (which has been removed from an inner/lower portion of the combined affixing and tamper indicating means) enables the removed portions to be clearly visible on an outer/upper side of the tamper indicating means thereby indicating that the cover has been tampered with, for example an attempt has been made to remove the cover having been affixed to the surface.

Without limiting the scope of the claims, an advantage/technical effect of some examples of the present disclosure may be to provide a waterproof and yet breathable protective covering that can form a protective seal over and around forensic evidence, thereby protecting the evidence from exposure to the elements, not least for example rain, whilst the breathability of the cover allows any moisture within the encapsulated forensic evidence to escape and may thereby prevent the build-up of mould and/or condensation which may otherwise degrade the forensic evidence. Furthermore, the provision of tamper indicating means helps establish and validate the integrity of the forensic evidence, i.e. so as to establish that it has not been tampered or interfered with whilst it has been covered and protected by the protective cover.

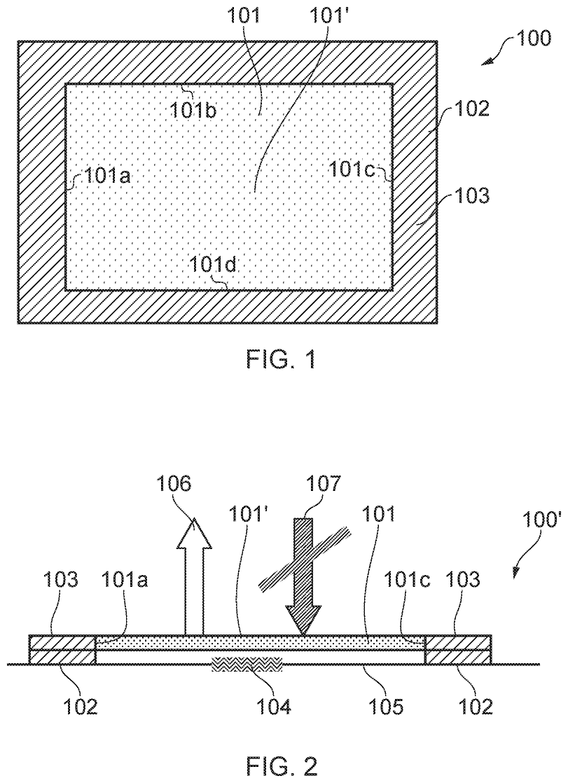

FIG. 1 focuses on the functional components necessary for describing the operation of the cover 100.

The cover 100 comprises a covering member 101 that is configured to be both breathable and waterproof. In this regard, the cover member may be made from one or more layers/membranes of one or more fabrics/materials which are duly configured (e.g. treated/coated) so as to provide both breathability as well as waterproofing, i.e. such that the covering member provides air permeability and permits water vapour to pass therethrough but does not provide liquid permeability and prevents/resists liquid water passing there through.

In various examples, the covering member is configured to be breathable so as to provide a moisture vapour transmission rate of one or more of: >5,000 g/m²/day, >7,500 g/m²/day, >10,000 g/m²/day (using the “Upright Cup test”—ISO 2528: 2017, JIS [Japanese Industry Standards] L 1099, JIS Z 0208, Desiccant Method of ASTM E96, JIS K 6328.

In various examples, the covering member is also configured to be waterproof, so as to have a waterproof rating of one or more of: >5,000 mm, between 6,000 to 10,000 mm, or greater than 10,000 mm (using the “hydro static head test” of withstand a pressure of X mm of water pressure (9.8 kPa) without leaking).

The peripheral edges 101a-d of the covering member 101 are provided with affixing means 102 and tamper indicating means 103.

The affixing means are configured so as to enable the cover to be affixed to a surface, thereby defining an affixed condition 100′. In various examples, the affixing means may comprise adhesive means for adhering the cover to a surface. The affixing means 102 are provided at each peripheral edge of the covering member surrounds and encloses a central portion 101′ of the covering member thereby defining a central portion of the covering member devoid of affixing means and also devoid of tamper indicating means, whereas the peripheral portions 101a-d of the covering member are provided with the affixing means 102 and tamper indicating means 103.

The affixing means may form a flange/peripheral region of the cover that surrounds/encircles the central portion of the covering member. The affixing means may enable, in use when placed over a piece of forensic evidence and affixed to a surface on which the forensic evidence is disposed, the forming of a (waterproof yet breathable) seal around the forensic evidence.

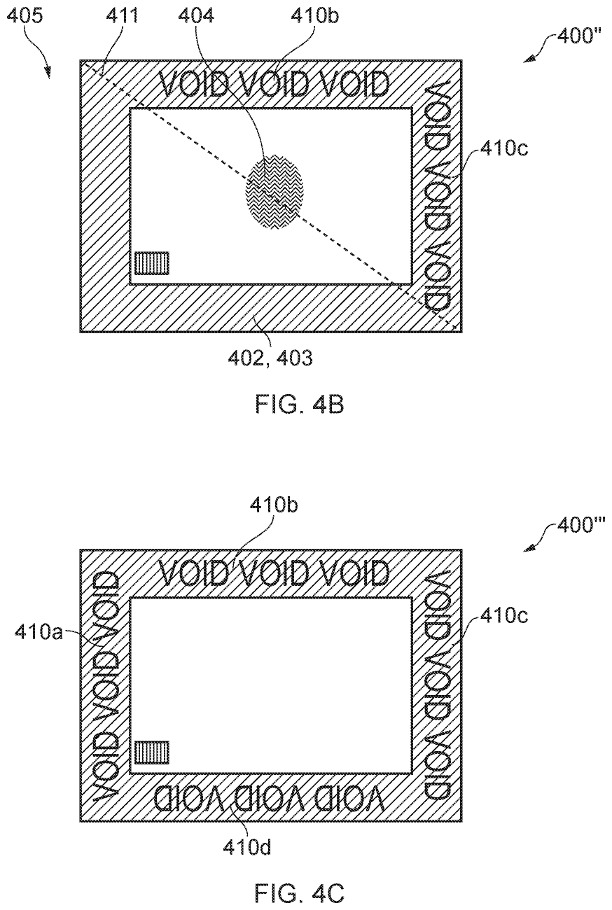

The tamper indicating means are also provided at each peripheral portion of the covering member. The tamper indicating means are configured so as to provide an indication of tampering of the cover (certain examples of which are discussed later with respect to FIGS. 4A-4D). Such an indication of tampering may be revealing a hidden message/pattern, or overt void identification that cannot be replaced or reapplied so as to highlight and enable quick and easy detection of unauthorised interfering/tampering.

In some examples, the tamper indicating means is integral with the affixing means. For example the affixing means and tamper indicating means may be provided in a tamper evident adhesive strip that surrounds and encloses a central portion of the covering member, i.e. a tamper evident adhesive strip is applied around the edges of central portion of the covering member.

In some examples, the tamper indicating means comprises an adhesive layer or tape that, once applied to a surface and, upon tampering (e.g. attempted and/or actual removal from the surface), leaves a permanent/semi-permanent or persistent residue of adhesive or artefact (e.g. deformity to the surface, such as tearing of fibres of a fibrous surface) on the surface to which the tamper indicating means was applied to. Alternatively, the tamper indicating means may be configured so as to be frangible/self destructing, for example so as to split, break or fail in a particular visual or mechanical way thereby providing a clear visual indication that tampering, i.e. attempted removal of the cover once affixed/adhered to a surface, has taken place.

The indication of the tampering may be by virtue of leaving marks or a pattern on the tamper indicating means itself or on the surface to which the cover has been affixed to. The tamper indicating means may provide a voiding system in which, upon tampering, a hidden message is revealed or an overt void tampering indication is provided that cannot be replaced or reapplied, thereby providing an easy detection of tampering. Such a voiding message may be provided by a tamper evident tape provided around the edges of the covering member that reveals a voiding message (not least for example “void” or some other tamper evident message or pattern). When the tamper evident tape, having been applied to a surface, is removed, i.e. due to tampering, the tape delaminates leaving behind some or all of its adhesive and moreover revealing the tamper evident message/pattern thereby making it not possible to reuse and reapply the tape. It will be appreciated that any custom/bespoke message or tamper evident pattern may be provided.

The tamper indicating means could be configured as a “non-residue” tamper evident system, for example wherein a hidden message or tamper evident pattern is revealed on the tamper indicating means itself when tampered with/removed from an applied surface, with no residue left behind on the actual surface. Alternatively the tamper indicating means may be provided as a “partial residue” system in which a message or pattern may be left behind on the surface, but that can be readily removed, for example by being rubbed out, without any lasting residue on the surface. It being appreciated that the tamper indicating means itself would still clearly indicate a voiding message that cannot be undone.

The tamper indicating means may be configured to provide an indication of one or more of:
Physical tampering of the cover, for example physical manipulation of the cover such as attempted removal of the cover once in an affixed condition. Such indication of tampering may be via exposing/revealing of a voiding message or pattern upon tampering/attempted removal once affixed. Alternatively or in addition, the tamper indicating means may use one or more of: security cuts, permanent adhesive/residue or the use of non-residue adhesive.
Thermal tampering of the cover, for example thermal manipulation of the cover by attempted heating/cooling of the cover, for example in an attempt to seek to nullify, negate or defeat the adhesion and/or tamper indicating means. Thermochromic ink could be used in this regard.
Chemical tampering of the cover, for example chemical manipulation of the cover, such as the attempted application of chemicals/solvents to the cover in an attempt to nullify/negate and defeat the affixing means and/or tamper indicating means. Chemically reactive ink may be used in this regard.

In some examples, the cover may be configured so as to provide protection from ultraviolet radiation. For example, the covering member may be configured so as to provide protection from ultraviolet radiation so as to prevent degradation of forensic evidence.

The covering member may be configured as one or more of: a sheet-like member, a planar member and a flexible member. The covering member may comprise one or more laminate layers/membranes. In certain examples, the covering member may be configured as a semi-rigid structure or a rigid structure, for example so as to provide a frame-like structure to overlay forensic evidence.

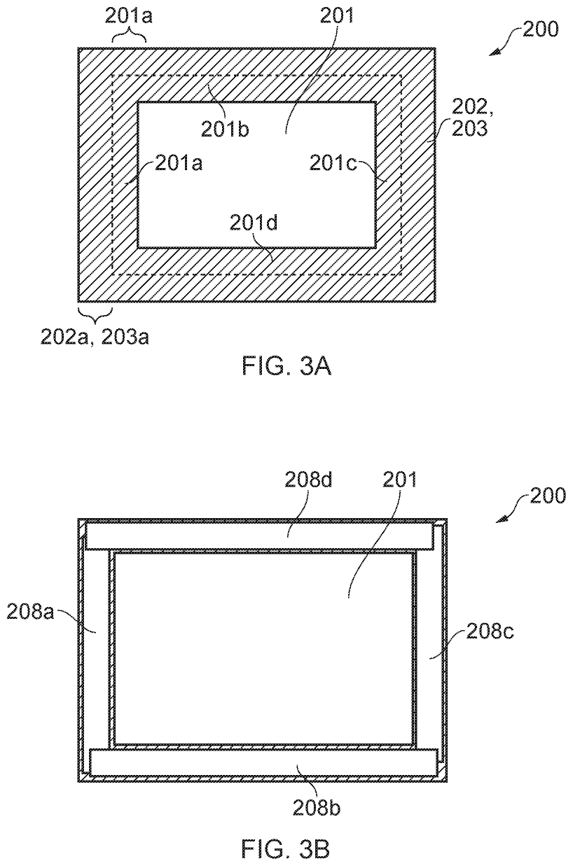

FIG. 2 schematically illustrates a side-on view of the apparatus 100 of FIG. 1 in use, i.e. in an affixed condition 100′ in which the cover has been affixed to a surface 105 overlaying a piece of forensic evidence 104 (for example a fingerprint). As schematically illustrated in FIG. 2 (which is not to scale) the affixing means 102 comprises the tamper indicating means 103, i.e. they are integral with one another, so as to both affix the cover to the surface as well as providing tamper indication upon attempted removal of the cover from the surface.

The covering member 101 is configured so as to be breathable (as schematically indicated by arrow 106) so as to permit water vapour to pass through the covering member, in particular its central region 101′ (which is not covered affixing means or the tamper indicating means). The covering member is also configured so as to be waterproof (as schematically illustrated by the struck-through arrow 107) so as to prevent/resist the passage of water therethrough.

The covering member may be configured so as to provide a unidirectional breathability, so as to permit the egress of water vapour and inhibit the ingress of water vapour. Advantageously, such unidirectional breathability may enable the drying out of the forensic evidence 104 and the sealed environment contained under the affixed cover (even in a humid/moist ambient conditions) whilst preventing both liquid ingress as well as moisture vapour ingress through the covering member into the sealed environment underneath the covering member in the affixed condition, which may otherwise moisten or dampen the forensic evidence.

The affixing means may be configured so as to provide a seal around the forensic evidence, thereby providing a substantially waterproof seal when in the affixed condition.

The covering member may be a planar/sheet-like member having a rectilinear shape with a plurality of peripheral edges, each edge of which is provided with the affixing means and tamper indicating means. It is to be appreciated that the covering member may be of any shape and size. For example, the covering member may be circular, i.e. having only a single encircling/circumferential peripheral edge. Such a single circumferential peripheral edge being provided with the affixing means and tamper indicating means such that they completely surround an encompass the circumferential edge of the circular covering member leaving a central region of the covering member devoid of any such affixing means or tamper indicating means.

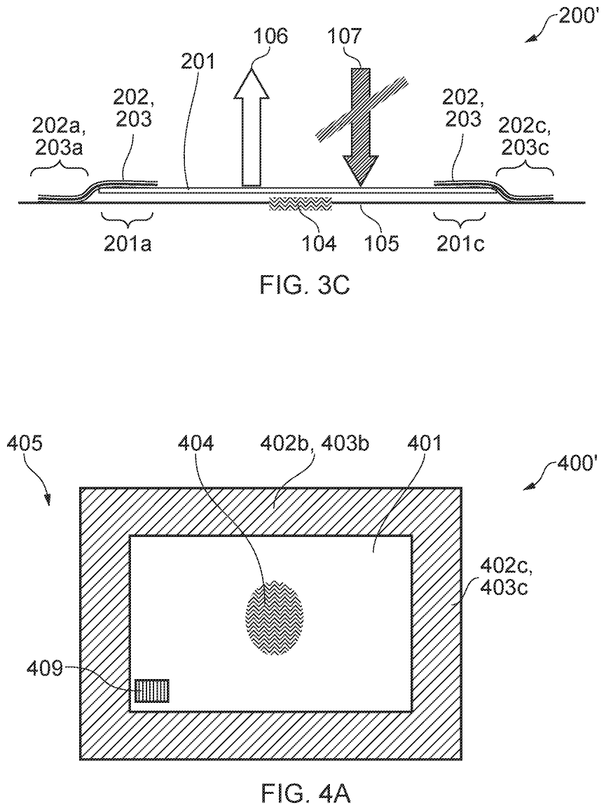

The affixing means and tamper indicating means may be provided at or proximal to each peripheral edge of the covering member. As illustrated in FIGS. 3A and 3, the affixing means and tamper indicating means may be provided overlaying the externally facing/upper side of the covering member at a peripheral portion thereof and be configured so as to overlap the peripheral portion thereby providing a flange portion of the affixing means and tamper indicating means that surround and encircle the covering member. Alternatively, (not shown) the affixing means and tamper indicating means may be provided underlying an internally facing/lower side of the cover, i.e. an underside of the covering member so as to form a band that encircles/surrounds a central region of the underside of the cover member (with the central region of the cover member being devoid of affixing and tamper indicating means).

FIG. 3A shows a plan view of a cover 200 wherein the affixing means 202 and tamper indicating means 203 are integral with one another, i.e. such that the tamper indicating means 203 itself provides the affixing means 202 for affixing/adhering the cover to a surface 105. In the cover 200, the combined tamper indicating means and affixing means are provided as a tamper evident adhesive strip/tape that overlays the peripheral portions 201a-d of the covering member 201 and overlaps the same so as to provide a flange portion 302a, 303a of the tamper indicating and affixing means.

FIG. 3B shows an underside/bottom view of the apparatus 200 prior to being placed in an affixed condition. The overlapping flange portions od the tamper indicating and affixing means are provided with/underlaid with one or more backing tapes, peelable strips or release liners 208a-d that are configured so as to be readily peeled from the adhesive tamper indicating means by a user (without triggering the tamper indicating mechanism) thereby exposing the flange portion of the adhesive tamper indicating means ready for application and adhesion to a surface, i.e. placing the cover in the affixed condition 200′ as per FIG. 3C.

FIG. 3C shows a side-on view of the cover in an affixed configuration 200′, i.e. where the cover has been affixed to the surface 105, overlaying forensic evidence 104, sealing the forensic evidence 104 within the affixed cover 200′ and enabling the egress of water vapour (as indicated by arrow 106) and resisting the ingress of liquid (as indicated by the struck-through arrow 107).

FIG. 4A schematically shows a cover in an affixed condition 400′ in that it has been affixed to a surface 405 over forensic evidence 404. In the apparatus shown in FIG. 4A, the cover is additionally provided with a unique identifier 409, in this case a barcode/machine readable code. Although it is appreciated that any unique identifier may be provided, not least for example a unique serial number so as to enable each individual cover to be uniquely identified.

FIG. 4B schematically illustrates the cover having been tampered with 400″. In this example, the top portion 402b, 403b and the right side portion 402c, 403c of the cover have been removed from their affixed position on the surface 405 (i.e. they have been peeled away from the surface and folded along crease line 411—e.g. to seek to interfere with the evidence—and then replaced back in position over the surface). Such tampering thereby activates the tamper indicating mechanism of the tamper indicating means in the affected top and right side portions 402b, 403b and 402c, 403c.

In this example, such tampering reveals a voiding message “VOID” 410b and 410c that is visible on the tamper indicating means 402, 403 in the affected portions thereof 402b, 403b and 402c, 403c. The lower and left hand side of the cover remain affixed to the surface and hence no voiding message has been revealed in these sections.

FIG. 4C schematically illustrates a further example of the cover having been tampered with 400′″. FIG. 4C shows the cover, having been previously placed in an affixed position on a surface, in a tampered condition 400′ in that is has been fully removed from the surface. Here, the voiding messages/tamper indications 410a-410d have been revealed by the tamper indicating means on each peripheral side.

The tamper indicating means of the cover may provide an indication of tampering both on the cover itself (e.g. via the tamper evident indications 410a-410d of FIG. 4C) and/or on the surface (e.g. via tamper evident indications such as tamper indicating message/pattern residue 410′a-410′d of FIG. 4D).

FIG. 4D schematically illustrates an example of a tamper indication provided by cover whose the tamper indicating means is configured to leave a residue 410′a-410′d (e.g. a permanent or semi-permanent residue) on the surface 405 to which the cover has been affixed following the tampering/removal of the cover from the surface. In the examples of FIG. 4D, with the cover having been removed, a residue 410′a-410′d from the tamper indicating means is left behind and remains on the surface 405, in this case a voiding message “VOID” 410′a-410′d.

The cover may be manufactured in differing sizes for differing intended use, for example the cover may be dimensioned so as to overlay/protect a fingerprint, or a hand print, a foot print or to cover objects which may be used as evidence or potential evidence thereon (for example blood or other bodily fluids). In some examples, the cover may be made having dimensions suitably sized for providing a covering and protection for a human fingerprint or a hand print, for example dimensions that have a length and/or width: <10 cm, <20 cm, <30 cm, <40 cm, <50 cm, or between 50 and 100 cm.

In some examples, the protective cover may be manufactured so as to have a dimension of greater than 100 cm, for example having dimensions sufficient to cover an entryway to a forensic scene, for example to cover a door, window, passageway to a forensic scene (for example a room, alley way or area where a crime/accident/incident has occurred) so as to protect forensic evidence in such a forensic scene from tampering/interfering by providing a tamper indicating barrier to the entryway to the forensic scene such that any attempted entry to the forensic scene, once the cover has been affixed to the entryway, would be readily identified and determined from the tamper indicating means.

Where the cover is intended to protect forensic evidence, for example fingerprints or blood marks on a surface (not least for example a window, door, wall, floor . . . ) it may be desirable that the covering member is transparent so as to permit user identification of the forensic evidence being protected. Where the cover is used to protect an entire forensic scene, i.e. to protect a room, it may be desirable for the cover to be made of an opaque material such that the scene is hidden from external view and shields the incident and investigation from view.

The aforementioned covers may be used and combined in a modular manner, for example so as to be combined together to provide a single larger composite cover formed of a plurality of covers affixed together, thereby increasing the total size/area which can be protected.

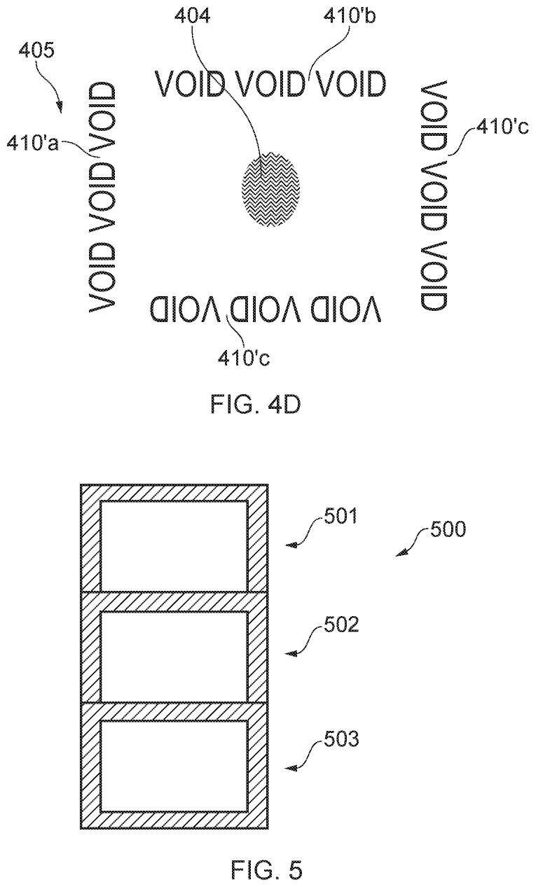

FIG. 5 schematically illustrates a system 500 for use in a forensic scene, such as a crime or accident scene, comprising a plurality of covers 501, 502 and 503 (similar to the covers previously described). A user is able to affix one cover to another, via their respective affixing means, so as to create a composite protective cover that can protect/cover large extended areas/surfaces.

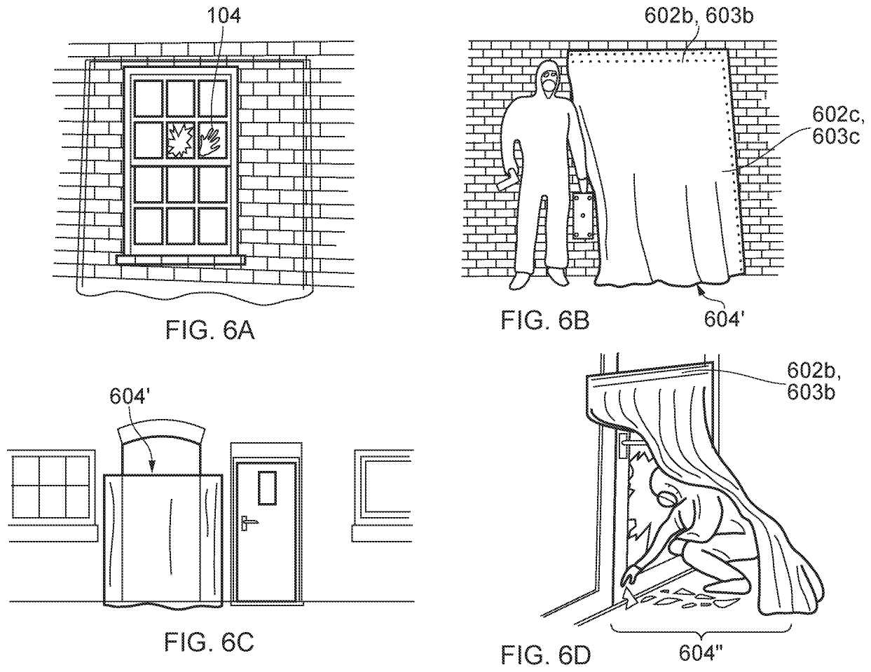

In some examples, the cover may be provided as a sheet having dimensions in excess of 1 metre so as to cover extended areas and surfaces. Such large sized covers may be used to cover entryways to a forensic scene, for example to cover an entire window (as shown in FIG. 6A), a doorway as shown in FIG. 6B or an alleyway as shown in FIG. 6C.

Whilst the cover may be provided with tamper indicating and adhesive means on each of its peripheral sides, in use, only one or more of the sides may be used to partially affix the cover to a surface. For example, as indicated in FIG. 6B, the upper side tamper indicating adhesive portions 602b, 603b and the right side tamper indicating adhesive portions 602c, 603c have been exposed and used to affix the cover around a doorway, whilst the backing/release strips are kept in position for the left most and bottom peripheral side portions of the cover so as to enable a user to have access and egress to the scene 604′ but preventing any view into the scene by the public or media. In effect the cover may act as a curtain over the entrance to a scene and hide the scene (and the on-going investigation) from view from the public and media. Similarly FIG. 6C illustrates the cover being used to hide a forensic scene 604′ from view and block entry to the scene, moreover, ensuring the integrity of the hidden scene by providing tamper indication if the cover were to be removed from its affixed position.

FIG. 6D shows a further use of a cover acting as a shield to a forensic scene 604″ to protect it from the elements. For example, when a crime scene investigating officer attends to examine a scene, if it is raining, damp, snowing, misty or foggy, it can be difficult if not impossible for the crime scene investigating officer to examine the outside of a scene. The powders and chemicals that are typically used in crime scene investigations are highly moisture sensitive. Accordingly, any moisture in and around the forensic evidence may render the chemicals unusable for the purposes of examination. FIG. 6D shows the cover in use with the topmost peripheral edge tamper indicating and affixing means 602b, 603b being used to adhere to a surface with the crime scene investigating officer able to go underneath the cover and conduct an examination away from the elements with the cover preventing rain from falling on the surface of the potential evidence.

The tamper indicating means are configured that, once applied, and when subsequently sought to be removed, an indication of such tampering is provided. Such an indication may be via self-evident destruction of the tamper indicating means, or the revealing of patterns or messages indicating such tampering on the tamper indicating means itself as well as the surface to which it had been applied.

The affixing means and tamper indicating means may be provided in the form of a tamper evident strip which is attached in such a manner that it adheres to an upper external surface of the covering mechanism, but overhangs/overlaps the edges of the same so as to provide flange portions of the tamper evident strip which provides immediate visual recognition of the strip, having been applied to a surface, has been tampered with, such as if an attempt has been made to remove the tamper evident strip from a surface having been adhered to the same. Such immediate visual recognition of tampering may correspond to the leaving of a predetermined die cut portion of the adhesion on the surface. The removal of such adhesion portion from the tamper evident strip may be clearly visible to an outer side of the tamper evidence strip thereby providing an immediate visual recognition that the tamper evident strip has been tampered with.

The tamper evidence strip may be applied around the edges of the covering member during the manufacturing process by any appropriate technique, not least for example adhesion, stitching, heat sealing or heat welding the tamper evidence strip and the covering member together.

The distance or width around the edges of the tamper evidence strip, i.e. the flange portion, may vary in dimension on desired usage. The central portion of the covering member, which is bounded by the tamper evident strip around its edges, is not provided with any adhesive to prevent damage to or compromise of the evidence once covered, as such central regions of the covering member would overlay the evidence in use.

The cover may be of any size, shape or colour. The covering medium may be made of a material coated in polyurethane (PU) and may range in density from 4 oz (113.4 grams) PU upwards. The covering member may be made of a material having a waterproof membrane with a rating of 6,000-10,000 mm or higher. The covering member may be configured so as to provide wind proofing quality.

Each individual cover may be provided with a unique reference number from a barcode or machine readable code, for example printed onto its surface, which can then further assist in providing a user with the continuity and integrity of the scene or evidence the cover is protecting.

The tamper indicating means may provide a tamper evident strip/tape/seal which has die or laser cut portions provided therein which can be cut to suit the desired wording or design of tamper indication. The design or wording may be die or laser cut into the tamper evident tape's surface such that if the tamper evident strip is attempted to be removed from the adhered surface, the tape delaminates leaving on the surface some or all of its adhesive, revealing the tamper evident pattern or wording. This makes it not possible to simply reapply the tamper evident strip as the indication of the tampering is instantly visible.

The tamper indicating means may be initially provided and covered with a protective backing film which is removed by a user to expose the adhesive thereon and allowing the sheet to be attached to a surface.

In one example of possible use of the cover, a first responder police officer attending a crime scene (such as a burglary, criminal damage, minor assault, vehicle crime) could assess the site for most likely forensic potentials such as the point of entry or exit, footwear marks, prior attempts, visible blood, saliva etc. and cover such potential forensic evidence with covers thereby protecting the potential forensic evidence from the elements and accidental damage and moreover providing a continuity of the integrity and authenticity of the evidence by virtue of the tamper indicting means providing an assurance that the forensic evidence protected thereby has not been tampered with.

In addition to providing protection for forensic evidence and covering the same, the cover may also be used as a screen to shield potentially sensitive scenes from public or media view. The covers may be provided in a range of sizes and dimensions, some suitable for protecting individual object and items of forensic evidence with others being sized so as to cover windows, doors, and entryways.

In other examples, once a room, building, vehicle or area has been searched (for example for harmful devices, listening devices) such as prior to a VIP visit or a royal visit, it can be sealed using the cover of its entry points such as doors and windows and the security, continuity and integrity of the evidence, building, room or area which has been sealed can be proven and established by virtue of the tamper indicating means. For example, it would be immediately obvious if any tampering had taken place subsequently since the search took place, thereby saving time, costs and resources, for example instead of having an officer attending and monitoring the cite at all times.

Rather than having several officers physically stood outside every point of entry to a serious incident scene, the cover can be used to seal doors/windows/alleyways in a tamper evident manner which reduces the cost of scene guarding and provides integrity and continuity of the scene and prevents view into the scene by the public or media. Scene investigators could seal the scene and make a note of a unique reference number applied to each cover used, then, when they return, the tamper indicating means of the covers may be quickly checked to ensure complete integrity and continuity of the scene in question.

If specialist lighting examinations are required during a serious/major crime scene investigation, the forensic scene (room, building, vehicle . . . ) may need to be made light tight for various lasers or lights to be used. In which case, the cover may be attached over doors, windows, windscreens . . . so as to quickly and easily form a light tight area for use. For such specific usages, the cover may be configured so as to ensure it is “light tight” and provide adequate blackout properties, for example a thicker material may be used.

Although specific terms are employed herein, they are used in a generic and descriptive sense only and not for purposes of limitation.

Features described in the preceding description may be used in combinations other than the combinations explicitly described. Although functions have been described with reference to certain features, those functions may be performable by other features whether described or not. Although features have been described with reference to certain examples, those features may also be present in other examples whether described or not. Accordingly, features described in relation to one example/aspect of the disclosure may include any or all of the features described in relation to another example/aspect of the disclosure, and vice versa, to the extent that they are not mutually inconsistent.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are to be interpreted as “at least one” [feature, element, component, means . . . ] unless explicitly stated otherwise.

The above description describes some examples of the present disclosure however those of ordinary skill in the art will be aware of possible alternative structure and features which offer equivalent functionality to the specific examples of such structures and features described herein above and which for the sake of brevity and clarity have been omitted from the above description. Nonetheless, the above description should be read as implicitly including reference to such alternative structures and features which provide equivalent functionality unless such alternative structures or features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims may be suitably combined in any manner apparent to one of ordinary skill in the art.

Each and every claim is incorporated as further disclosure into the specification and the claims are embodiment(s) of the present invention. Further, while the claims herein are provided as comprising specific dependencies, it is contemplated that any claims may depend from any other claims and that to the extent that any alternative embodiments may result from combining, integrating, and/or omitting features of the various claims and/or changing dependencies of claims, any such alternative embodiments and their equivalents are also within the scope of the disclosure.

1. A cover for protecting forensic evidence, the cover comprising:
a covering member for at least partially covering forensic evidence, wherein the covering member is configured to be breathable and waterproof;
affixing means for affixing the cover to a surface in an affixed condition, wherein the affixing means is provided at each peripheral edge of the covering member; and
tampering indicating means for indicating tampering of the cover in the affixed condition, wherein the tampering indicating means is provided at each peripheral edge of the covering member.

2. The cover of claim 1, wherein the affixing means comprises the tampering indicating means.

3. The cover of claim 1, wherein the tamper indicating means is configured to provide an indication of one or more of:
physical tempering of the cover;
thermal tampering of the cover; and
chemical tampering of the cover.

4. The cover of claim 1, wherein the affixing means is configured to provide a substantially waterproof seal when in the affixed condition.

5. The cover of claim 1, wherein the affixing means comprises adhesive means.

6. The cover of claim 5, wherein the adhesive means comprises a band of adhesive provided on one side of the cover, wherein the band of adhesive surrounds at least a central portion of the covering member.

7. The cover of claim 1, wherein the covering member is opaque.

8. The cover of claim 1, wherein the covering member is transparent.

9. The cover of claim 1, wherein the covering member is configured to provide protection from ultraviolet radiation.

10. The cover of claim 1, wherein the covering member is configured as one or more of: a sheet-like member, a planar member and a flexible member.

11. The cover of claim 1, wherein the cover is provided with a unique identifier.

12. A system for use in a crime or accident scene, the system comprising:
a first cover as claimed in claim 1;
a second cover as claimed in claim 1, wherein the second cover is affixable to the first cover by the affixing means of the first cover.

13. A method of protecting forensic evidence and/or forensic scene, the method comprising:
affixing a cover as claimed in claim 1 around forensic evidence and/or an entryway to a forensic scene.
